(19) United States
(12) Patent Application Publication
(10) Pub. No.: US 2026/0222073 A1
(43) Pub. Date: Jul. 30, 2026

(54) OPTIMIZED CONTROL BUS FOR PHOTONIC RESONATOR CONTROL

(71) Applicant: HEWLETT PACKARD ENTERPRISE DEVELOPMENT LP, Spring, TX (US)

(72) Inventors: SAI RAHUL CHALAMALASETTI, Milpitas, CA (US); Marco Fiorentino, Milpitas, CA (US); Joseph Chang, Spring, TX (US); Chaerin Hong, Spring, TX (US)

(21) Appl. No.: 19/037,973

(22) Filed: Jan. 27, 2025

(51) Int. Cl. H04B 10/50; G02B 6/293; H04B 10/572

(52) U.S. Cl. CPC H04B 10/506; G02B 6/293; H04B 10/572

(57) ABSTRACT

Systems and methods are provided for controlling a plurality optical resonators along a common control bus. Examples include a plurality of resonators coupled to a plurality of tuning mechanisms, a control bus connected to the plurality of tuning mechanisms, and a resonator controller configured to input a data stream onto the control bus. The data stream includes a plurality of request data packets which are being assigned to respective ones of the plurality of resonators. The plurality of tuning mechanisms are configured to adjust resonance wavelengths of the plurality of resonators based on receiving the data stream.

### BACKGROUND

In recent years, photonic resonators (also referred to as optical resonators) have increasingly been employed as components in optical networks and other nanophotonic systems that are integrated with electronic devices. A resonator can be configured with a resonance wavelength substantially matching a particular wavelength of light. When the resonator is positioned adjacent to a waveguide within the evanescent field of light propagating along the waveguide, the resonator evanescently couples at least a portion of the particular wavelength of light from the waveguide and traps the light for a period of time. Resonators can be well-suited for use in modulators and detectors in nanophotonic systems employing wavelength division multiplexing (“WDM”). These systems transmit and receive data encoded in different wavelengths of light that can be simultaneously carried by a single optical fiber or waveguide. Resonators can be positioned at appropriate points along the optical fiber or waveguide and operated to encode information by modulating unmodulated wavelengths of light and operated to detect wavelengths of light coding information and convert the encoded wavelengths into electronic signals for processing.

### BRIEF DESCRIPTION OF THE DRAWINGS

The present disclosure, in accordance with one or more various examples, is described in detail with reference to the following figures. The figures are provided for purposes of illustration only and merely depict typical, non-limiting aspects of such examples.

FIG. 1 illustrates an example of an optical communication system in which the examples of the present disclosure can be implemented.

FIG. 2 depicts a schematic block diagram of a tuning system, in accordance with examples of the present disclosure.

FIG. 3 illustrates an example request data packet, in accordance with examples of the present disclosure.

FIG. 4 illustrates an example response data packet, in accordance with examples of the present disclosure.

FIG. 5 is a schematic diagram of an example resonator driver, in accordance with an example of the present disclosure.

FIG. 6 is a schematic diagram of another example resonator driver, in accordance with an example of the present disclosure.

FIG. 7 illustrates an example request data packet, in accordance with an example of the present disclosure.

FIG. 8 illustrates an example response data packet, in accordance with an example of the present disclosure.

FIG. 9 illustrates another example request data packet, in accordance with an example of the present disclosure.

FIG. 10 illustrates another example response data packet 1000, in accordance with an example of the present disclosure.

FIG. 11 is a computing component that may be used to implement examples of the disclosed technology.

FIG. 12 depicts a block diagram of an example computer system in which various examples of the disclosed technology described herein may be implemented.

The figures are not exhaustive and do not limit the present disclosure to the precise form disclosed.

### DETAILED DESCRIPTION

As outlined above, optical resonators can be an important component of optical networks and other photonic systems integrated with electronic devices. However, an optical resonator's dimensions may affect the resonator's resonance wavelength, which can be important because in various phonetic systems (such as WDM systems) the wavelengths may be separated by fractions of a nanometer. Environmental factors affecting an optical resonator's resonance wavelength may include low resonator temperatures due to low ambient temperature or lack of power dissipation of neighboring circuits, which can cause the resonance wavelength to drift (e.g., shift from the desired wavelength). In addition, even with today's microscale fabrication technology, fabricating optical resonators with the dimensional precision to insure that the optical resonator's resonance wavelength matches a particular wavelength of light can be difficult. These problems arise because the resonance wavelength of a resonator may be inversely related to the resonator's size. In other words, the resonance wavelength of a small resonator can be more sensitive to variations in resonator size than that of a relatively larger resonator. For example, a deviation of just 10 nm in the radius of a nominally 10 μm radius resonator results in a resonance wavelength deviation of 1.55 nm from the nominal resonance wavelength for which the ring resonator was designed. This 0.1% deviation approaches the limits in accuracy for fabricating resonators using optical lithography. A deviation of this magnitude may be undesirable and in typical optical networks and microscale optical devices where the wavelength spacing may be less than 1 nm.

To mitigate deviations in resonance wavelengths, the optical resonators may be tuned to induce wavelength-shifts of the resonance wavelengths. Such shifts in resonance wavelengths can be used to counter fabrication variations and/or environmental fluctuations described above.

Conventional approaches to tuning optical resonators utilized traditional memory mapped bus interfaces (e.g., AXI memory and the like). In these cases, request and response paths and the number of input/output signals added logic complexity and required additional on chip real-estate, which in turn consumed more power and negatively impacted latency. For example, conventional approaches relied on distinct request and response paths between a controller and each optical resonator. Thus, as the number of optical resonators increased, the number of request and response paths proportionally increased. Additionally, input/output signaling on the various paths added complexity to the logic to ensure that the signals were synchronized and properly registered, as well as increased latency between signaling.

The examples disclosed herein overcome the technical shortcomings of the conventional approaches by providing a control protocol for controlling a plurality optical resonators along a common control bus. A data stream of data packets can then be supplied to the control bus. Each data packet is assigned to a particular optical resonator. The optical resonators can act on (e.g., be tuned) according to only those data packets there to assigned, while the other data packets of the data stream can be passed to downstream optical resonators.

For example, a plurality of optical resonators can be coupled to a plurality of tuning mechanisms, such that each optical resonator is coupled to at least one tuning mechanism. The tuning mechanisms can be operated to adjust a resonance wavelength of a respectively coupled optical resonator. The plurality of tuning mechanisms can be electrically connected to the control bus via respective resonator drivers. Each optical resonator may be associated with a resonator driver that can be configured to ingest data packets from the control bus and drive associated tuning mechanisms to adjust a resonance wavelength of the respectively coupled optical resonator according to data packets assigned to the respectively coupled optical resonator. For example, the resonator drivers may obtain a parameter (referred to as a tuning parameter), such as a voltage bias, from an assigned data packet and the parameter can be applied to a tuning mechanism to adjust an operational attribute. Based on the tuning parameter, the resonator driver can cause the tuning mechanism to induce a change in the resonance wavelength of the respectively coupled optical resonator by can applying the tuning parameter to the tuning mechanism.

In examples, a resonator controller, such as but not limited to a microprocessor or microcontroller, can be connected to an input of the control bus and configured to input a data stream onto the control bus. The data stream may comprise a plurality of request data packets, each of which can be assigned to a particular optical resonator. In examples, each of the request data packets comprises a header carrying a resonator identifier (ID) specifying the optical resonator assigned to the particular request data packet and a payload carrying at least one tuning parameter for driving at least one tuning mechanism coupled to the optical resonator specified in the header. Since the resonator drivers are each connected to the control bus, each resonator driver may receive the plurality of request data packets. However, each resonator driver may act on only those request data packets that contain a resonator ID corresponding to the optical resonator associated with the respective resonator driver.

In examples, the resonator drivers receive the plurality of request data packets and drive tuning mechanisms coupled to an associated optical resonator based on a comparison of the resonator IDs contained in the plurality of request data packets against a locally stored ID of a respective resonator. If a resonator ID specified in a request data packet matches the locally stored ID of the respective optical resonator, the request data packet can be accepted by resonator driver for controlling the tuning mechanism coupled to the respective optical resonator. For example, a given resonator driver may receive each request data packet of the plurality of request data packets, which may include a first request data packet followed, in time, by one or more subsequent request data packets. In this case, the resonator driver may receive the first request data packet and compare the resonator ID in the first request data packet to the locally stored ID. If the resonator ID specified in the first request data packet matches the locally stored ID, the first request data packet is accepted. The payload of the first request data packet can be forwarded to the tuning mechanism and the tuning mechanism can be driven/controlled according to the tuning parameter contained in the payload.

The resonator driver can also generate a control signal that can be provided to a photodetector coupled to the respective optical resonator. The photodetector measures a result (e.g., an optical signal on the respective optical resonator). The resonator driver can read the result and constructs a response data packet by populating a payload with the result. In examples, the result may be a measure of the optical power or amplitude of the optical signal detected by the photodetector. The resonator driver can also populate a header with the locally stored ID of the respective optical resonator.

The resonator driver can be configured to hold or otherwise delay any request data packets that are received subsequent to the first request data packet, in this example, and are not assigned to the respective optical resonator. For example, those request data packets that contain resonator IDs that do not match the locally stored ID can be held or otherwise delayed. While holding the subsequent request data packets, the resonator driver may insert a constructed response data packet into the data stream in place of the first request data packet. Once inserted, the resonator driver may then release the held request data packets, including the inserted response data packet, onto the control bus.

Where the resonator ID of a request data packet does not match the locally stored ID, the request data packet can be passed through to a downstream optical resonator. In this case, the request data packet may be held or otherwise delayed, as described above, if a preceding data packet in the data stream included a resonator ID that matched the locally stored ID.

The above examples of the disclosed technology overcome the technical issues by providing a single, common control bus over which the stream of request data packets can be provided that reduces the number of response and request paths (e.g., fewer wires), as well as input/output signals, needed to effectuate control of the optical resonators. Essentially, examples herein provide a single response and request path over the common control bus. Additionally, the resonators drivers according to examples herein can consume less on-chip real-estate and offer lower power consumption compared to the conventional approaches. Furthermore, the comparison based logic implemented by the resonator drivers can lead to reduced latency between photodetector reads as compared to the conventional approaches that utilize a more complex logic due to the memory mapped bus interfaces.

It should be noted that the terms “optimize,” “optimal” and the like as used herein can be used to mean making or achieving performance as effective or perfect as possible. However, as one of ordinary skill in the art reading this document will recognize, perfection cannot always be achieved. Accordingly, these terms can also encompass making or achieving performance as good or effective as possible or practical under the given circumstances, or making or achieving performance better than that which can be achieved with other settings or parameters.

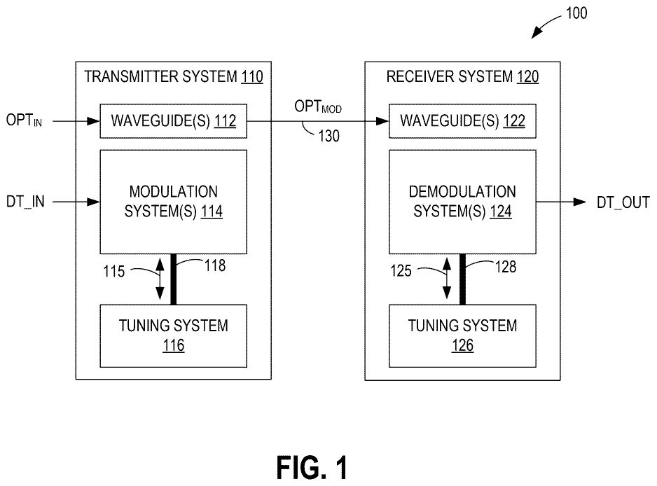

FIG. 1 illustrates an example of an optical communication system 100 in which the examples of the present disclosure can be implemented. The optical communication system 100 can be implemented in any of a variety of optical communications applications to transmit data. The optical communication system 100 includes a transmitter system 110 and a receiver system 120 that can be coupled to each other via an optical transmission medium 130. As an example, the optical transmission medium 130 can be configured as any of a variety of different types of optical transmission media, such as an optical fiber (e.g., fiber optic cable), waveguide, or a variety of other media through which an optical signal can propagate. As an example, the optical communication system 100 can be implemented as an optical interconnect system. An optical interconnect system can be implemented for optical communication between separate electronic devices, as well as any other applications in which optical signals are used for performing computations (e.g., photonic computing, machine learning, and the like).

The transmitter system 110 can be configured to receive and modulate an optical signal OPT_{IN} based on one or more input data signals DT_IN, and provide the modulated optical signal, demonstrated in the example of FIG. 1 as an optical signal OPT_{MOD}, to the receiver system 120. As an example, the transmitter system 110 can be configured to implement wavelength division multiplexing (e.g., dense wavelength division multiplexing (DWDM)) and/or time division multiplexing (TDM) in modulating the optical signal OPT_{IN}. The receiver system 120 can be configured to receive the modulated optical signal OPT_{MOD} and to demodulate the modulated optical signal OPT_{MOD} to provide one or more data output signals, demonstrated in the example of FIG. 1 as output data signals DT_OUT.

The transmitter system 110, in the example of FIG. 1, includes one or more waveguide(s) 112 that can be configured to receive the optical signal OPT_{IN}. As an example, the optical signal OPT_{IN} can be generated as a multi-wavelength optical signal, such as via a single comb light source. Alternatively, the optical signal OPT_{IN} can be generated via a laser bank (e.g., a distributed feedback (DFB) laser bank). The transmitter system 110 may also include one or more modulation system(s) 114 that are configured to modulate the optical signal OPT_{IN} propagating in the waveguide(s) 112 based on the input data signal(s) DT_IN.

As an example, each of the modulation system(s) 114 can include an optical resonator, such as ring resonator (e.g., MRR), that can be optically coupled (e.g., evanescently or otherwise photonically coupled) to the one or more waveguide(s) 112. In some examples, the optical resonators may include one or more Mach-Zehnder Interferometers (MZIs), as well as MZIs having one or more MRRs coupled there to (e.g., a MRR assisted MZI). In the case of ring resonators, each ring resonator can have a radius corresponding to a resonant wavelength of a wavelength of the optical signal OPT_{IN}. Thus, in this case, the ring resonator of a respective one of the modulation system(s) 114 can be configured to resonate the respective wavelength of the optical signal OPT_{IN} in response to the input data signal(s) DT_IN to modulate the optical signal OPT_{IN} by removing the respective wavelength from the optical signal OPT_{IN}. For example, the input data signal(s) DT_IN can be provided via a PIN diode to provide carrier injection in the ring resonator to provide optical coupling between the respective ring resonator and the waveguide to facilitate modulation with respect to the respective wavelength. Therefore, the modulated optical signal OPT_{MOD} can correspond to the optical signal OPT_{IN} that is modulated via the input data signal(s) DT_IN.

In the example of FIG. 1, the transmitter system 110 can also include a tuning system 116. The optical resonators in each of the modulation system(s) 114 can be rendered susceptible to fabrication variations and environmental fluctuations based on specific wavelength-selectivity. Therefore, the tuning system 116 can be implemented to wavelength-shifts of the resonance wavelengths of the optical resonators included in the modulation system(s) 114. Such shifts in resonance wavelengths may mitigate wavelength drifts that can occur with respect to each of the modulation system(s) 114, such as resulting from fabrication variations and/or environmental fluctuations (e.g., temperature).

As an example, the tuning system 116 can be configured to induce such wavelength-shifts based on feedback from the modulation system(s) 114. For example, the tuning system 116 can be configured to monitor an intensity of a portion of an optical signal resonating in the optical resonator associated with the respective one of the modulation system(s) 114. When the intensity is below a threshold level indicative of a wavelength drift, the tuning system 116 may be configured to adjust a bias signal(s) (e.g., voltage bias) associated with tuning mechanism(s) (also referred to herein as tuning mechanism(s)) to induce a change in a resonance wavelength that mitigates the wavelength drift. Mitigating such drifts can ensure the optical resonators can modulate the optical signal OPT_{IN} at the respective wavelength according to input data signal DT_IN. Thus, the tuning system 116 can provide rapid tuning mechanisms that induces a change in the resonance wavelength of the optical resonators. In addition, the tuning system 116 can also include other tuning mechanisms, such as thermal tuning, to provide greater tuning flexibility.

In the example of FIG. 1, the tuning system 116 can be configured to utilize a control bus 118 that interfaces with the modulation system(s) 114 for inducing changes in the resonance wavelengths. For example, the control bus 118 can be connected to the tuning mechanisms for interfacing with the optical resonators of the modulation system(s) 114. In examples, the control bus 118 can interface with each optical resonator in a serial arrangement, whereby each optical resonator interfaces with the control bus in a series (e.g., one after another).

The tuning system 116 may be configured to generate a data stream 115 and input the data stream 115 onto the control bus 118. The data stream 115 may comprise a plurality of request data packets, each of which can be assigned to a particular optical resonator of modulation system(s) 114. In examples, each of the request data packets may comprise a resonator ID specifying an optical resonator of the modulation system(s) 114 assigned to the respective request data packet and at least one tuning parameter for driving tuning mechanism(s) associated with the optical resonator specified by the resonator ID. For example, the tuning parameter may be bias value (e.g., a value of a voltage bias) that can be used to adjust a bias signal applied to a tuning mechanism for inducing a wavelength-shift of the optical resonator.

In examples, the optical resonators of modulation system(s) 114 are each connected to the control bus 118 (e.g., the control bus is common for the optical resonator), such that each optical resonator can receive each of the request data packets. However, by virtue of the resonator IDs, the optical resonators may be manipulated according to only those request data packets that contain a resonator ID corresponding to a respective optical resonator. For example, a resonator ID specified in a request data packet can be compared to a local ID of an optical resonator and if there is a match, the tuning mechanism may be driven according to a tuning parameter contained in the request data packet. Otherwise, the request data packet can be passed through to a next optical resonator.

The receiver system 120 may include one or more waveguide(s) 122 that are configured to receive the modulated optical signal OPT_{MOD}. The receiver system 120 also can include one or more demodulation system(s) 124 that are configured to demodulate the modulated optical signal OPT_{MOD} propagating in the one or more waveguide(s) 122 to provide the output data signal(s) DT_OUT.

As an example, each of the demodulation system(s) 124 can include a resonator, such as ring resonator (e.g., MRR), that is optically coupled (e.g., evanescently or otherwise photonically coupled) to the one or more waveguide(s) 122. In some examples, the optical resonators may include one or more MZIs, as well as MRR assisted MZIs. In the case of ring resonators, the rings may have a radius corresponding to a resonance wavelength of a given one wavelength of the modulated optical signal OPT_{MOD}. Thus, the resonator of the respective one of the demodulation system(s) 124 can be configured to resonate the respective wavelength of the modulated optical signal OPT_{MOD} to provide the respective output data signal(s) DT_OUT.

In the example of FIG. 1, the receiver system 120 can also include a tuning system 126 that can correspond, respectively, to the at least one of demodulation system(s) 124. As described previously, optical resonators, such as the ring resonators, in each of the demodulation system(s) 124 can be susceptible to fabrication variations and environmental fluctuations based on specific wavelength-selectivity. Therefore, the tuning system 126 can be implemented to mitigate wavelength drifts that can occur with respect to the demodulation system(s) 124, such as resulting from fabrication variations and/or environmental fluctuations (e.g., temperature). The tuning system 126 can operate substantially similar to the tuning system 116 of the transmitter system 110. The tuning system 126 can also utilize a control bus 128 over which a data stream 125 can be provided to the optical resonators, in a manner substantially similar to the tuning system 116 described above.

The optical communication system 100 can be implemented as an optical interconnect system for optical communication between separate electronic devices. For example, the transmitter system 110 and/or the receiver system 120 of the optical communication system 100 can be implemented on an integrated circuit (IC) chip, or as a combination of chips. As another example, the optical communication system 100 can be implemented in a transceiver system, such that the transmitter system 110 and the receiver system 120 are not coupled via the optical transmission medium 130, but are instead both arranged on a single IC chip to respectively transmit and receive modulated optical signals individually. For example, the optical communication system 100 can be implemented as a transceiver IC that includes a complementary metal-oxide semiconductor (CMOS) chip that is flip-chip bonded to a photonic chip to provide optical communication capability. Accordingly, the optical communication system 100 can be implemented in a variety of ways.

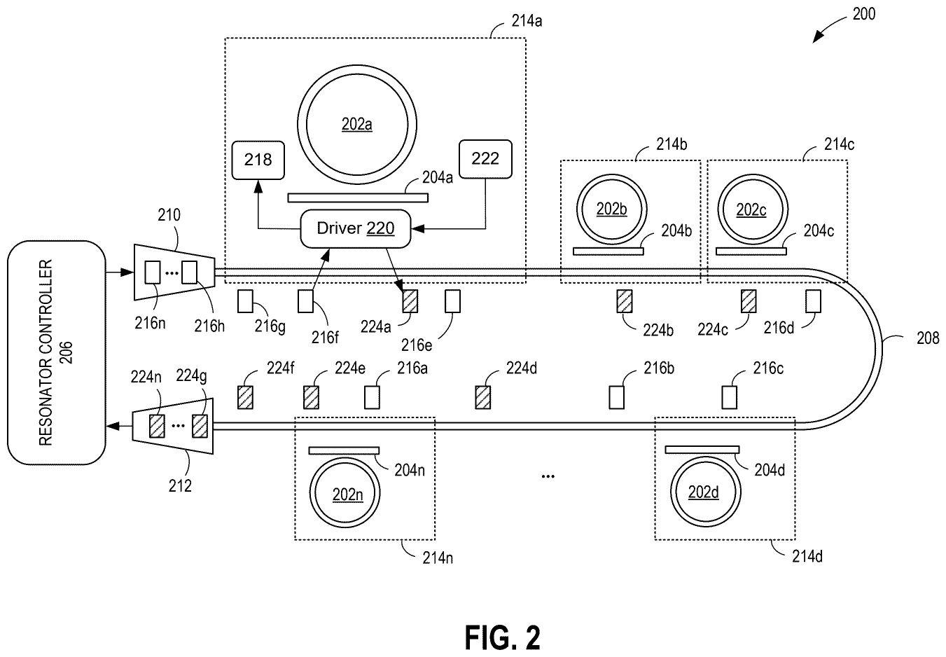

FIG. 2 depicts a schematic block diagram of a tuning system 200, in accordance with examples of the present disclosure. FIG. 2 provides an example tuning system 200 that can be configured to induce wavelength-shifts in a plurality of optical resonators 202a-202n. The optical resonators 202a-202n may be optically coupled (e.g., evanescently or otherwise photonically coupled) to waveguide(s) 204a-204n. In some examples, the optical resonators 202a-202n may be example implementations of modulation system(s) 114 and/or demodulation system(s) 124 and the waveguides 204a-204n may be example implementations of waveguide(s) 112 and/or waveguide(s) 122 of FIG. 1.

The tuning system 200 comprises a resonator controller 206 connected to a control bus 208 via an input buffer 210 and an output buffer 212. The control bus 208 can be communicatively connected to a plurality of resonator units 214a-214n (collectively referred to herein as resonator units 214 or individually referred to herein as resonator unit 214). The resonator units 214 may be serially arranged along the control bus 208.

The resonator units 214 may comprise the optical resonators 206a-206noptically coupled to waveguide 204a-204n. That is, each resonator unit 214 may comprise one of the optical resonators 206a-206n and a corresponding one of the waveguides 204a-204n. Each resonator unit 214 may also include one or more tuning mechanisms coupled to a respective optical resonator 202a-206n, which can be driven by a resonator driver. For example, referring to resonator unit 214 as an illustrative example of resonator units 214, optical resonator 202a is coupled to a tuning mechanism 218, which can be controlled by the resonator driver 220. The resonator driver 220 may provide control signals to the tuning mechanism 218 to adjust an operational attribute to induce a change in the resonance wavelength of the optical resonator 202a. For example, the resonator driver 220 may obtain a tuning parameter, such as a bias value. The resonator driver 220 may then adjust an operational attribute, such as a bias signal, applied to the tuning mechanism 218. As a result of adjusting the bias signal, the tuning mechanism 218 may cause a change in an effective index of refraction of the optical resonator 202a, thereby inducing a change in the resonance wavelength.

The tuning mechanism 218 may be implemented as any device that can be controlled to induce a change in a resonance wavelength of a coupled optical resonator. The tuning mechanism 218 may be implemented as any phase-shifter known in the art, for example but not limited to, a resistive heater, a MOSCAP, and the like. In the case of a resistive heater, a voltage bias applied to the resistive heater may cause a change in temperature that can heats the optical resonator (e.g., a waveguide forming a MRR in some examples). Heating the optical resonator causes a change in the refractive index of the optical resonator that shifts the resonance wavelength of the optical resonator. In the case of a MOSCAP, a voltage bias applied across an anode and cathode of the MOSCAP may induce carrier accumulation or depletion in optical resonator (e.g., in a waveguide forming a MRR in some examples). The changes in carrier concentration changes the refractive index of the optical resonator, thereby inducing a shift in the resonance wavelength.

Resonator unit 214a, in the example of FIG. 2, also includes a photodetector 222 for monitoring an intensity of an optical signal resonating in the optical resonator 202a. For example, the photodetector 222 may be coupled to the optical resonator 202a and used to detect an intensity of an optical signal in the optical resonator 202a. In another example, the photodetector 222 may be coupled to an output end of the waveguide 204a for detecting an intensity of the optical signal coupled out of the optical resonator 202a and into the waveguide 204a. In yet another example, the photodetector 222 may be coupled to a drop waveguide optically coupled to the optical resonator 202a for monitoring a drop optical signal coupled out of the optical resonator 202a. In any case, monitoring the intensity of an optical signal via the photodetector 222 may be used to ensure that the resonance wavelength of the optical resonator 202a is tuned accordingly.

The resonator controller 208 can be configured to create a stream of data packets (also referred to as a data stream) containing information for driving resonator units 214. As shown in FIG. 2, the data stream may comprise a plurality of request data packets 216a-216n (collectively referred to herein as request data packets 216 or individually referred to herein as request data packet 216), each of which can be assigned to a particular resonator unit 214. In examples, each request data packet 216 may include a resonator ID specifying an optical resonator 202a-202n of an assigned resonator unit 214 and at least one tuning parameter for driving a tuning mechanism of the assigned resonator unit 214. As an illustrative example, request data packet 216f may be assigned to resonator unit 214a by including a resonator ID of optical resonator 202a. Request data packet 214f may include a tuning parameter for driving tuning mechanism 218, which may be obtained by the resonator driver 220 and used for adjusting an operational attribute of the tuning mechanism 218.

The resonator controller 206 may generate the data stream and add each request data packet to a queue in input buffer 210. Input buffer 210 may be, for example, a first-in-first-out (FIFO) buffer that sequentially inputs each request data packet onto the control bus 208 in the order generated by the resonator controller 206.

Since each resonator unit 214 is connected to the control bus 208, each respective resonator driver (e.g., resonator driver 220 of resonator unit 214a as an example) may receive each of the request data packets 216 of the data stream. In examples, each resonator unit 214 may act on only those request data packets 216 that contain a resonator ID corresponding to its respective optical resonator 202. For example, upon receiving a request data packet 216, the resonator unit 214 can compare the resonator ID of the request data packet to a local ID stored at a resonator unit 214. If the resonator ID matches the local ID, the request data packet 216 can be accepted by a respective resonator driver and a tuning parameter contained in the request data packet 216 can be used for controlling respective tuning mechanism.

Based on (e.g., responsive to) a match determination, the resonator unit 214 may generate a control signal to read an intensity of an optical signal monitored by a respective photodetector. The resonator unit 214 may construct a response data packet that contains the local ID and the result of the read (e.g., an intensity value). The response data packet can be added to the data stream as one of response data packets 224a-224n (collectively referred to herein as response data packets 224 or individually referred to herein as response data packet 224).

However, if the resonator ID does not match the local ID, the resonator unit 214 can be configured to hold or otherwise delay the request data packet 216, as well as any subsequently received request data packets that are not assigned to the respective resonator unit 214. While holding the request data packets 216, the resonator unit 214 may insert a constructed response data packet 224 into the data stream in place of a processed request data packet 216. Once inserted, the resonator unit 214 may then release the held request data packets 216, including the inserted response data packet 224, onto the control bus 208.

As an illustrative example, referring to resonator unit 214a, the resonator driver 220 receives each of the request data packets 216. For example, the resonator driver 220 receives request data packet 216f and checks if the resonator ID of request data packet 216f matches the local ID of optical resonator 202a. In this case, the obtained resonator ID matches the local ID and resonator driver 220 obtains the tuning parameter contained in the request data packet 216f. The resonator driver 220 may then drive the tuning mechanism 218 according to the tuning parameter to induce cause a shift in the resonance wavelength of the optical resonator 202a. Resonator driver 220 also generates a control signal that reads the intensity of an optical signal monitored by the photodetector 222 and constructs a response data packet 224a. The response data packet 224a is populated with the result of the read and the local ID of the optical resonator 202a. The resonator driver 220 may supply the constructed response data packet 224a to the control bus 208 by inserting the response data packet 224a into the data stream.

Assume, while resonator driver 220 is processing request data packet 216f and constructing response data packet 224a, resonator driver 220 receives request data packet 216g (as well as additional subsequent request data packets). In this case, assume the resonator ID of the request data packet 216g does not match the local ID. As a result, the resonator driver 220 can be configured to hold or otherwise delay the request data packet 216g, as well as any subsequent request data packets. While holding the request data packet 216g (and any subsequent request data packets), the resonator driver 220 may insert the constructed response data packet 224a into the data stream in place of the request data packet 216f. Once inserted, the resonator driver 220 may then release the held request data packets 216, including the inserted response data packet 224a, onto the control bus 208. That is, in the example of FIG. 2, the data stream may include request data packet 216e followed by response data packet 224a, which is followed by request data packet 216g (and any other subsequent request data packets 216 that are not assigned to resonator unit 214a).

The control bus 208 adds response data packets 224 (and any unprocessed request data packets 216) to a queue in output buffer 212. Output buffer 212 may be, for example, a first-in-first-out (FIFO) buffer that sequentially outputs each data packet of the data stream to the resonator controller 206 in the order received from the control bus 208.

In examples, the resonator controller 206 may generate new request data packets 216 based on the response data packets 224. For example, resonator controller 206 may be configured to obtain the results from response data packets 224 and populate new request data packets 216 with tuning parameters based on the results. As an example, a response data packet 224 constructed by resonator unit 214a may include a reading indicating that optical resonator 202a is experience wavelength drift, for example, due to environmental fluctuations. Based on this, the resonator controller 206 may generate a new request data packet 216 for resonator unit 214a that increments the tuning parameter in a manner to mitigate the wavelength drift. Resonator controller 206 may then insert the new request data packet 216 into the data stream via input buffer 210. Resonator controller 206 may increment the tuning parameter by a pre-defined step (e.g., increment a voltage bias by a pre-defined amount, such as .01V or other value as desired).

As noted above, optical resonators can be susceptible to fabrication variations and/or environmental fluctuations. In some cases, a subset of optical resonators (e.g., one or more optical resonators) may be more susceptible to such variations, for example, due to a location that is more exposed to environmental conditions and/or due to fabrication tolerances or inconsistencies. To mitigate this susceptibility, the subset of optical resonators may require more frequent monitoring and tuning to mitigate wavelength-drift due to such variations. Examples herein can be implemented to provide weighted monitoring and tuning in which certain optical resonators can be driven and monitored at a more frequent rate than those that are not as susceptible. For example, assume optical resonator 202d is positioned closer to a heat source than the other optical resonators 202a-202c and 202n. In this case, resonator controller 206 may generate a greater number of request data packet 216 assigned to the optical resonator 202d, which can result in a proportionate number of response data packets 224 being created by the resonator unit 214d. The increased number of response data packets 224 can provide for more frequent monitoring of the operation of optical resonator 202d.

In some examples, the relative wavelength of the monitoring of the optical resonators may be based on the relative susceptibility of the optical resonators to fabrication variations and/or environmental fluctuations. For example, one subset of optical resonators may be highly susceptible, a second subset may be somewhat susceptible, and a third subset may be negligibly susceptible. In this case, the number of request data packets generated for the first subset of optical resonators may be larger than the number generated for the second subset of optical resonators, which in turn may be larger than the number generated for the third subset. Thus, the first subset would be tuned and monitored at the fastest rate, while the third subset would be tuned and monitored at the slowest rate.

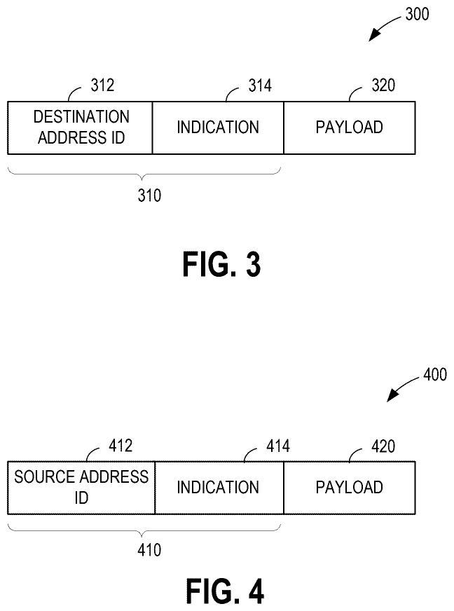

FIG. 3 illustrates an example request data packet 300, in accordance with examples of the present disclosure. Request data packet 300 may be an example of one of request data packets 216 of FIG. 2 generated by the resonator controller 206. In the example of FIG. 3, the request data packet 300 includes a header field 310 and a payload 320.

The header field 310 includes a destination address ID field 312 and an identification field 314. The destination address ID field 312 can be populated with a resonator ID as the destination address ID. The identification field 314 may be populated with data that indicates that the data packet is a request data packet and that the data packet is to be processed by a resonator driver (e.g., resonator driver 220). In examples, the identification field 314 may be populated with information specifying that the data packet is a request data packet, for example, by including a flag that indicates the data packet contains tuning parameter data. In operation, a resonator driver may receiver data packet 300 and read the identification field 314. If the flag in the identification field 314 indicates that the data packet 300 contains tuning parameter data, the resonator driver may process the data packet by checking the resonator ID contained in the destination address ID field 312. If the resonator ID matches a local ID, the resonator driver may then obtain the tuning parameter contained in the payload field 320 to adjust an operation attribute of a tuning mechanism (e.g., tuning mechanism 218).

FIG. 4 illustrates an example response data packet 400, in accordance with examples of the present disclosure. Response data packet 400 may be an example of one of response data packets 224 of FIG. 2 constructed by a resonator driver. In the example of FIG. 4, the response data packet 400 includes a header field 410 and a payload 420.

The header field 410 includes a source address ID field 412 and an identification field 414. The source address ID field 412 can be populated with a local ID of an optical resonator as the source address ID. The identification field 414 may be populated with data that indicates that the data packet is a response data packet and that the data packet is not to be processed by a resonator driver (e.g., resonator driver 220). In examples, the identification field 414 may be populated with information specifying that the data packet is a response data packet, for example, by including a flag that indicates the data packet contains photodetector data (e.g., an intensity value) resulting from reading a photodetector. In operation, a resonator driver may receiver data packet 400 and read the identification field 414. If the flag in the identification field 414 indicates that the data packet 400 contains intensity data, the resonator driver may not process the data packet. In some cases, the resonator driver may hold or otherwise delay the data packet 400 while processing a preceding request data packet.

A resonator driver may construct the response data packet 400 based on receiving a request data packet. That is, for example, upon acting on a request data packet to induce a change in a resonance wavelength of an optical resonator, the resonator driver may read a photodetector (e.g., photodetector 222) and populate the payload field 420 with the reading. The resonator driver may also populate the header field 410 with the local ID so to associate the reading with the optical resonator and toggle the flag to indicate that that the data packet is in fact a response data packet.

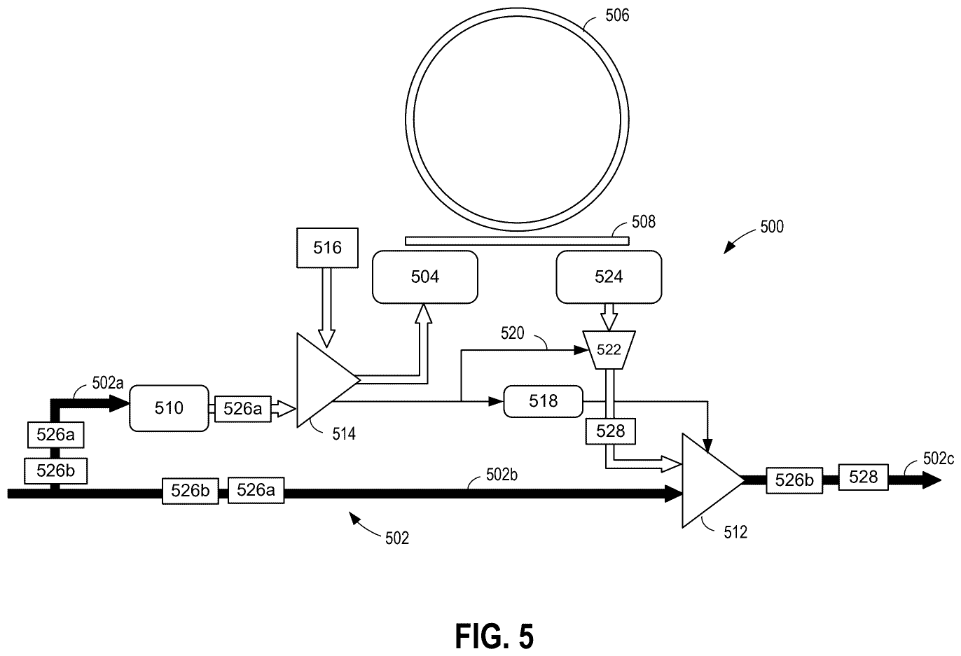

FIG. 5 is a schematic diagram of a resonator driver 500, in accordance with an example of the present disclosure. The resonator driver 500 may be connected to control bus 502 (shown as solid black arrows). The resonator driver 500 may be configured to adjust an operational attribute of a tuning mechanism 504 to induce a change in the resonance wavelength of an optical resonator 506 optically coupled to a waveguide 508. The resonator driver 500 may be an example implementation of resonator driver 220 of FIG. 2. Accordingly, the optical resonator 506, waveguide 508, control bus 502, and tuning mechanism 504 may be example implementations of an optical resonator 206, waveguide 204, control bus 208, and tuning mechanism 218 of FIG. 2.

Resonator driver 500 comprises a register 510 connected to a portion 502a of the control bus 502. The register 510 may be configured to receive data packets from the control bus, two of which are shown as data packet 526a and 526b. In examples, the register 510 may determine whether a received data packet is a request or response data packet. For example, register 510 may access an indication field of a data packet and read a flag therein. If the flag indicates that the data packet contains tuning parameter data (e.g., indication field 314 of FIG. 3), the register 510 may determine that the data packet is a request data packet (e.g., one of request data packets 216) and forward the data packet for further processing by the resonator driver 500 (shown in FIG. 5 as data packet 526a). If however, the flag indicates that the data packet contains photodetector data (e.g., indication field 414 of FIG. 3); the register 510 discards the data packet or otherwise ignores the data packet. In either case, the data packets may continue along portion 502b of the control bus 502 to a buffer stage 512, where the data packet is held in a queue with the rest of the data stream.

The resonator driver 500 also comprises a comparator 514 connected to register 510. The comparator 514 can be configured to evaluate a destination address ID field of the data packet (e.g., destination address ID 312 of FIG. 3) to determine if the data packet is assigned to the optical resonator 506. For example, responsive to register 510 determining that the data packet is a request data packet, the comparator 514 reads the resonator ID contained in the destination address ID field and compares the resonator ID to a local ID held in local data store 516 of the resonator driver 500. If the resonator ID matches the local ID, the comparator 514 obtains the tuning parameter data of the payload (e.g., payload 320 of FIG. 3) and resonator driver 500 drives the tuning mechanism 504 according to the tuning parameter, as described above in connection with FIGS. 1 and 2.

The comparator 514 may also trigger a counter 518 to wait an amount of time for the tuning mechanism to reach a steady state and effectuate the change in resonance wavelength of the optical resonator 506. The amount of time may be set as desired for a particular application. If comparator 514 does not identify a match, the counter 618 may be set to zero so to permit the buffer stage 512 to release the data stream.

The comparator 514 may also generate control signal 520 that can be forwarded to photodetector driver 522 that reads photodetector 524 (e.g., an example implementation of photodetector 222). Photodetector driver 522 may also be configured to create a response data packet 528 (e.g., response data packet 400 and/or one of response data packet 224). For example, photodetector driver 522 may populate a payload field of the response data packet with an intensity value read from the photodetector 524, as well as populate a source address ID field with the local ID of the optical resonator 506 and populate the indication field to indicate that the data packet is a response data packet. The photodetector driver 522 may be configured to provide the response data packet 528 to the buffer stage 512 (which may be implemented as a multiplexer logic stage).

The buffer stage 512 may insert the response data packet 528 into the data stream by replacing the data packet 526a (e.g., the request data packet in this example) with the response data packet 528. Once inserted, the buffer stage 512 can be triggered to release the data stream, including the response data packet 528, onto a third portion 502c of the control bus 502. The data stream may traverse the control bus to downstream resonator drivers for processing in a manner similar to the above.

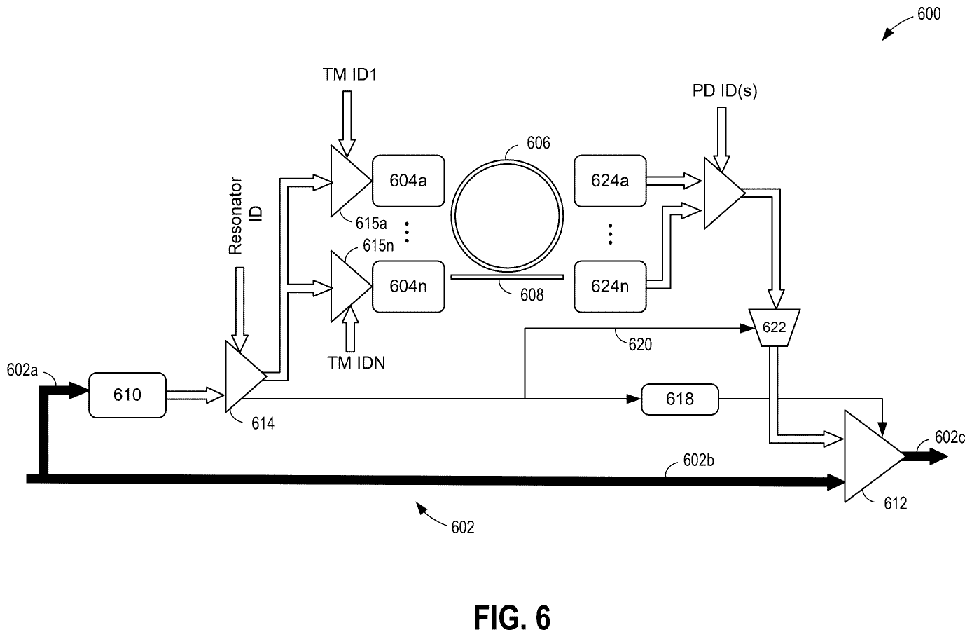

FIG. 6 is a schematic diagram of another resonator driver 600, in accordance with an example of the present disclosure. The resonator driver 600 may be connected to control bus 602 (shown as solid black arrows). The resonator driver 600 may be substantively similar to resonator driver 500, except that resonator drive 600 is configured to driver a plurality of tuning mechanisms 604a-604n. As such, similar to resonator driver 500, the optical resonator 606, waveguide 608, and control bus 602 may be example implementations of an optical resonator 206, waveguide 204, and control bus 208 of FIG. 2. Tuning mechanisms 504a-504n may be implemented as a plurality of tuning mechanisms 218, each of which may be controlled to induce a change in the resonance wavelength of the optical resonator 506.

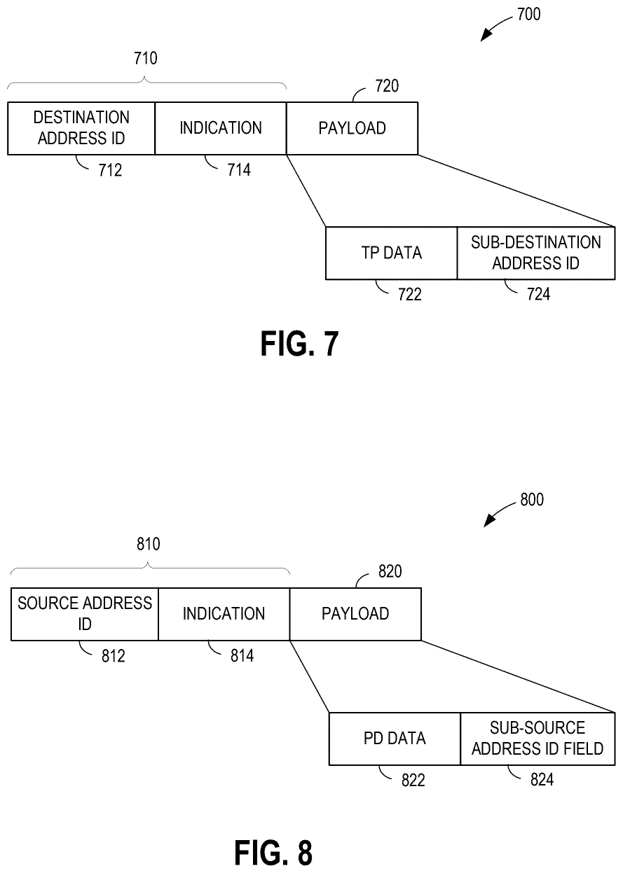

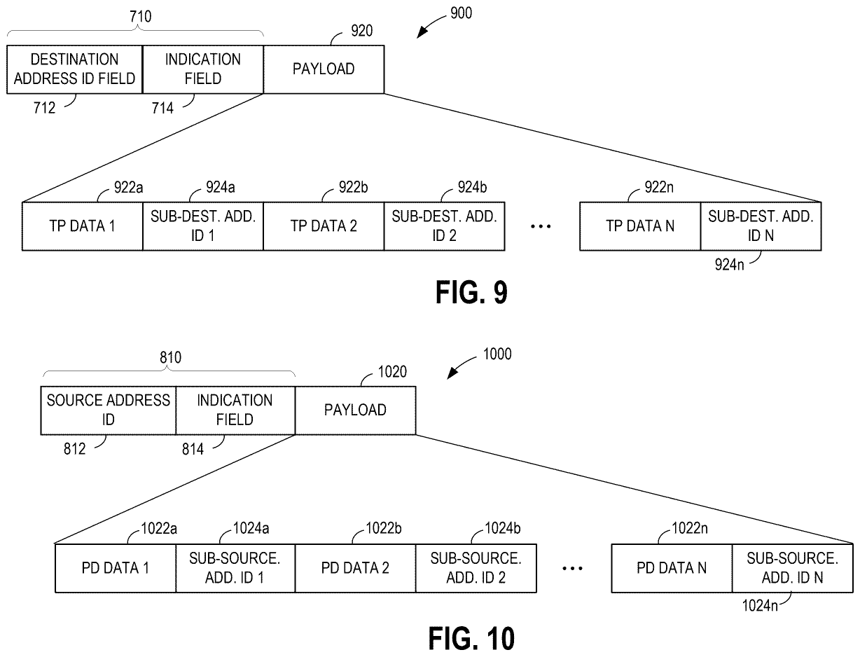

In the example of FIG. 6, resonator driver 600 comprises a register 610 connected to a portion 602a of the control bus 602. The register 610 may be configured to receive data packets from the control bus 602. The register 610 may determine whether each received data packet is a request or response data packet, for example, by checking an indication field of a data packet. If the register 610 determines that the data packet is a request data packet, the data packet can be forwarded to a first comparator 614. If however, the data packet is not a request data packet, the register 610 discards the data packet or otherwise ignores the data packet. In either case, the data packets may continue along portion 602b of the control bus 602 to a buffer stage 612, where the data packet is held in a queue with the rest of the data stream. FIGS. 7 and 9, described below, provide examples of request data packets that may be used by resonator driver 600 for driving a plurality of tuning mechanisms.

The resonator driver 600 also comprises the first comparator 614 that can be configured to evaluate a destination address ID field of the data packet and determine if the data packet is assigned to the optical resonator 606. For example, as described above, the first comparator 614 reads a resonator ID contained in a destination address ID field and compares the resonator ID to a local ID held in a local data store (e.g., similar to local data store 516) of the resonator driver 600 or held at the first comparator 614. If the resonator ID matches the local ID, the first comparator 614 passes the request data packet to a plurality of comparators 615a-615n. The number of comparators 615a-615n may coincide with the number of tuning mechanisms 604a-604n (e.g., two comparators 615a and 615n corresponding to tuning mechanisms 604a and 604n in this example).

The comparator 614 may also trigger a counter 618 to wait an amount of time for the tuning mechanisms to reach a steady state and effectuate the change in resonance wavelength of the optical resonator 606. The amount of time may be set as desired for a particular application. If comparator 614 does not identify a match, the counter 618 may be set to zero so to permit the buffer stage 612 to release the data stream.

Each comparator 615a-615n reads one or more tuning mechanism IDs contained in the request data packet. For example, each comparator 615a-615n reads a tuning mechanism ID contained in a sub-destination address ID field and compares the tuning mechanism ID to a local ID held at each comparator 615a-615n (e.g., at a register of the respective comparator). For any tuning mechanism ID that matches a local tuning mechanism ID, the corresponding comparators 615a-615n obtain tuning parameter data of the payload corresponding to the matched tuning mechanism ID and resonator driver 600 drives the respective tuning mechanisms 604a-604n according to the tuning parameter, as described above in connection with FIGS. 1 and 2.

As an illustrative example, comparator 615a may store a first tuning mechanism ID (TM ID1) corresponding to tuning mechanism 604a and comparator 615n may store an nth tuning mechanism ID (TM IDN) corresponding to tuning mechanism 604n. The first comparator 614 forwards a confirmed request data packet to the both comparators 615a and 615n. Comparator 615a obtains a tuning mechanism ID from the request data packet and checks if it matches the first tuning mechanism ID (TM ID1). If there is a match, the comparator 615a obtains tuning parameter data for driving tuning mechanism 604a and resonator driver 600 drives the tuning mechanism 604a according to the tuning parameter. Similarly, comparator 615n obtains a tuning mechanism ID from the request data packet and checks if it matches the nth tuning mechanism ID (TM IDN). If there is a match, the comparator 615n obtains tuning parameter data for driving tuning mechanism 604n and resonator driver 600 drives the tuning mechanism 604n according to the tuning parameter. If a match is not found, each comparator 615a-615n that did not recognize a match discards the data packet or otherwise ignores the data packet and the data packet may continue along portion 602b of the control bus 602 to buffer stage 612.

Once the counter 618 has expired (e.g., the amount of time has passed), a control signal 620 can be forwarded to photodetector driver 622 that reads photodetectors 624a-624n (e.g., each of which may be implemented as photodetector 222). Photodetector driver 622 may also be configured to create a response data packet (e.g., response data packet 400 and/or one of response data packet 224). For example, the photodetector driver 622 may populate a source address ID field with the local ID of the optical resonator 606 and populate the indication field to indicate that the data packet is a response data packet. Photodetector driver 622 may also populate a payload field of the response data packet with intensity values read from each photodetector 624a-624n and populate a sub-source address ID field with photodetector IDs associated with each read. The photodetector driver 622 may be configured to provide the response data packet 628 to the buffer stage 612 (which may be implemented as a multiplexer logic stage).

The number of photodetectors 624a-624n may coincide with the number of tuning mechanisms 604a-604n (e.g., two photodetectors 624a and 624n corresponding to tuning mechanisms 604a and 604n in this example). Each photodetector 624a-624n may be configured to monitor the intensity of a different portion of the optical signal resonating in the optical resonator 606. For example, a first photodetector 624a may be coupled to the optical resonator 606 and configured to monitor the optical signal resonating within the optical resonator 606, while a second photodetector 624n may be coupled to a drop waveguide (not shown) and configured to monitor a drop optical signal. As another example, a photodetector may be coupled to the waveguide 608 and configured to monitor the intensity of the optical signal coupled into the optical resonator 606 and/or out of the optical resonator 606. Such configurations may be useful, for example, where tuning mechanism 604a-604n are configured to tune different portions of the optical resonator (e.g., the optical resonator 606 or a coupling efficiency between waveguide 608 and optical resonator 606). As another example, optical resonator 606 may be implemented as a MRR assist MZI, which may comprise multiple optical paths and one or more MRRs. Each optical path and MRR may be independent tuned using distinct tuning mechanisms (e.g., multiple tuning mechanism of the same and/or different types), and various photodetectors may be utilized to monitor each distinct tuning mechanism.

The buffer stage 612 may insert the response data packet into the data stream by replacing the request data packet (e.g., the request data packet in this example) with the response data packet. Once inserted, the buffer stage 612 can be triggered to release the data stream, including the response data packet, onto a third portion 602c of the control bus 602. The data stream may traverse the control bus to downstream resonator drivers for processing in a manner similar to the above.

FIG. 7 illustrates an example request data packet 700, in accordance with an example of the present disclosure. Request data packet 700 may be an example of one of request data packets 216 of FIG. 2 generated by the resonator controller 206. In examples, the request data packet 700 may be utilized by resonator driver 600 to drive a plurality of tuning mechanisms. In the example of FIG. 7, the request data packet 700 includes a header field 710 and a payload 720.

In the example of FIG. 7, the header field 710 includes a destination address ID field 712 and an identification field 714. The destination address ID field 712 can be populated with a resonator ID as the destination address ID. The identification field 714 may be populated with data that indicates that the data packet is a request data packet and that the data packet is to be processed by a resonator driver (e.g., resonator driver 600).

The payload 720 comprises a sub-destination address ID field 724 and tuning parameter data field 722. The sub-destination address ID field 724 can be populated with a tuning mechanism ID that specified a tuning mechanism. The tuning parameter data field 722 may comprise tuning parameters, such as a voltage bias, that can be used by the resonator driver to adjust an operational attribute of the tuning mechanism identified in the sub-destination address ID field 724.

In operation, a resonator driver may receiver data packet 700 and read the identification field 714. If the flag in the identification field 714 indicates that the data packet 700 contains tuning parameter data, the resonator driver may process the data packet by checking the resonator ID contained in the destination address ID field 712. If the resonator ID matches a local ID, the resonator driver may check the check the tuning mechanism ID contained in the sub-destination address ID field 724. If the tuning mechanism ID matches a local tuning mechanism ID, the resonator driver may then obtain the tuning parameter contained in the tuning parameter data field 722 to adjust an operation attribute of the specified tuning mechanism.

In examples, the data packet 700 can be assigned to a specific tuning mechanism, as well as to a specific optical resonator. In this case, multiple instances of data packet 700 may be generated (e.g., by a resonator controller), with a number of the data packets may be assigned to a particular optical resonator and subsets of those data packets further assigned to ones of tuning mechanism coupled to the particular optical resonator. In this case, each of the subsets of data packets may include the resonator ID of the particular optical resonator and different tuning mechanism IDs corresponding to those tuning mechanism to which each data packet is assigned.

FIG. 8 illustrates an example response data packet 800, in accordance with an example of the present disclosure. Response data packet 800 may be an example of one of response data packets 224 of FIG. 2 constructed by a resonator driver (e.g., resonator driver 600) based receiving a request data packet 700. In examples, the response data packet 800 may be created by resonator driver 600 to communicate a photodetector reading result. In the example of FIG. 8, the request data packet 800 includes a header field 810 and a payload 820.

The header field 810 includes a source address ID field 812 and an identification field 714. The source address ID field 812 can be populated with a local ID of an optical resonator as the source address ID. The identification field 814 may be populated with data that indicates that the data packet is a response data packet and that the data packet is not to be processed by a resonator driver. In operation, a resonator driver may receiver data packet 800 and read the identification field 814. If the flag in the identification field 814 indicates that the data packet 800 contains photodetector data, the resonator driver may not process the data packet. In some cases, the resonator driver may hold or otherwise delay the data packet 800 while processing a preceding request data packet.

The payload 820 comprises a sub-source address ID field 824 and photodetector data field 822. The sub-destination address ID field 824 can be populated with a photodetector ID that specifies a photodetector. The photodetector data field 822 may comprise results of reading the specified photodetector, such as intensity values of a monitored portion of an optical signal.

A resonator driver may construct the response data packet 800 based on receiving a request data packet, such as request data packet 700. That is, for example, upon acting on a request data packet assigned to a particular tuning mechanism (e.g., as specified by a tuning mechanism ID), the resonator driver may read an associated photodetector (e.g., one of photodetectors 624a-624n). The resonator driver may populate the sub-source address ID field 822 with a photodetector ID corresponding to the read photodetector and populate the photodetector data field 822 with the reading. The resonator driver may also populate the source address ID field 812 with the local ID so to associate the reading with the optical resonator and toggle the flag in indication field 814 to indicate that that the data packet is in fact a response data packet. In examples, the resonator driver may construct distinct instances response data packets 800 for each photodetector that is read.

FIG. 9 illustrates another example request data packet 900, in accordance with an example of the present disclosure. Request data packet 900 may be an example of one of request data packets 216 of FIG. 2 generated by the resonator controller 206. In examples, the request data packet 900 may be utilized by resonator driver 600 to drive a plurality of tuning mechanisms. As such, request data packet 900 may be substantively similar to request data packet 700, except that request data packet 900 may specify a plurality of tuning mechanism and associated tuning parameter data in a payload 920.

For example, the request data packet 900 includes a header field 710 and a payload 920. The payload 920 comprises a plurality of sub-destination address ID fields 924a-924n, each containing a tuning mechanism ID. Payload 920 also includes a plurality of tuning parameter data fields 922a-922n, each of which comprises tuning parameters, such as a voltage bias, that can be used by the resonator driver to adjust an operational attribute of a tuning mechanism identified in an associated sub-destination address ID field 924a-924n. That is, for example, tuning parameter data field 922a contains tuning parameters for driving the tuning mechanism specified in sub-destination address ID field 924a. Thus, a single request data packet can be used for driving a plurality of tuning mechanism.

FIG. 10 illustrates another example response data packet 1000, in accordance with an example of the present disclosure. Response data packet 1000 may be an example of one of response data packets 224 of FIG. 2 constructed by a resonator driver (e.g., resonator driver 600) based receiving a request data packet 900. In examples, the response data packet 1000 may be created by resonator driver 600 to communicate a photodetector reading results from a plurality of photodetectors. Response data packet 1000 may be substantively similar to request data packet 800, except that request data packet 1000 may specify a plurality of photodetectors and reading results from each photodetector in a payload 1020.

For example, the response data packet 1000 includes a header field 810 and a payload 1020. The payload 1020 comprises a plurality of sub-source address ID fields 1024a-1024n, each containing a photodetector ID. Payload 1020 also includes a plurality of photodetector data fields 1022a-1022n, each of which comprises results of reading the plurality of photodetectors (e.g., photodetectors 624a-624n of FIG. 6), such as intensity values. Each photodetector data field 1022a-1022n corresponds to a sub-source address ID field 1024a-1024n. For example, photodetector data field 1022a contains results of reading the photodetector specified in sub-destination address ID field 1024a. Thus, a single request data packet can be used for reporting reading results from a plurality of photodetectors.

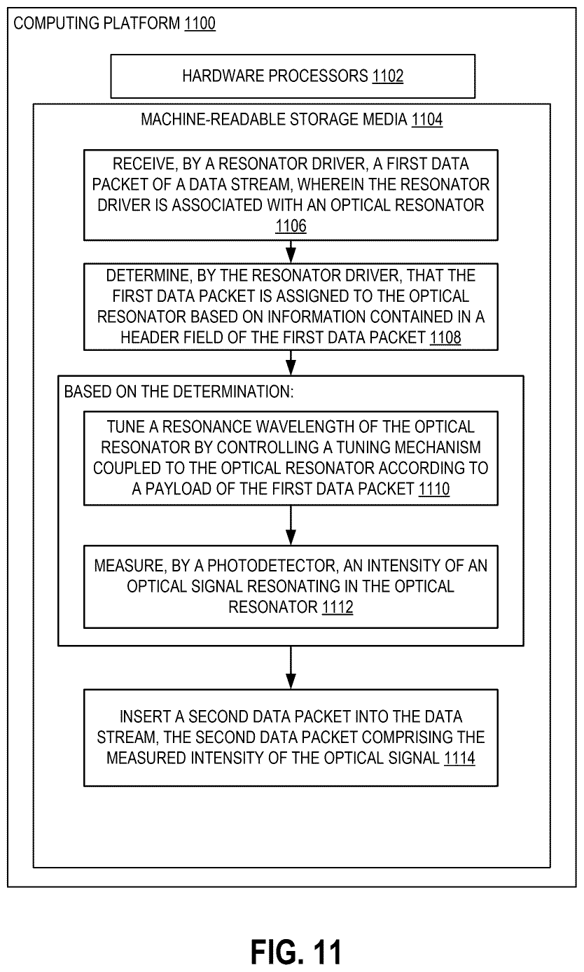

FIG. 11 illustrates a computing component that may be used to control optical resonators in accordance with various examples of the disclosed technology. Referring now to FIG. 11, computing component 1100 may be, for example, a server computer, a controller, or any other similar computing component capable of processing data. In the example implementation of FIG. 11, the computing component 1100 includes a hardware processor 1102, and machine-readable storage medium for 1104.

Hardware processor 1102 may be one or more central processing units (CPUs), semiconductor-based microprocessors, and/or other hardware devices suitable for retrieval and execution of instructions stored in machine-readable storage medium 1104. Hardware processor 1102 may fetch, decode, and execute instructions, such as instructions 1106-1114, to control processes or operations disclosed herein. As an alternative or in addition to retrieving and executing instructions, hardware processor 1102 may include one or more electronic circuits that include electronic components for performing the functionality of one or more instructions, such as a field programmable gate array (FPGA), application specific integrated circuit (ASIC), or other electronic circuits.

A machine-readable storage medium, such as machine-readable storage medium 1104, may be any electronic, magnetic, optical, or other physical storage device that contains or stores executable instructions. Thus, machine-readable storage medium 1104 may be, for example, Random Access Memory (RAM), non-volatile RAM (NVRAM), an Electrically Erasable Programmable Read-Only Memory (EEPROM), a storage device, an optical disc, and the like. In some examples, machine-readable storage medium 1104 may be a non-transitory storage medium, where the term “non-transitory” does not encompass transitory propagating signals. As described in detail below, machine-readable storage medium 1104 may be encoded with executable instructions, for example, instructions 1106-1114.

Hardware processor 1102 may execute instruction 1106 to receive, by a resonator driver, a first data packet of a data stream, wherein the resonator driver is associated with an optical resonator. For example, the hardware processor 1102 may execute instructions to create the data stream as a plurality of data packets that are input onto to a control bus, for example, as described above in connection with FIGS. 2-10. The resonator driver may be connected to the control bus and receive the first data packet of the data stream. The resonator driver, in some examples, may be implemented as resonator driver 220, 500, and/or 600 described above. The first data packet, in some examples, may be a request data packet (e.g., one of request data packets 216a-216n), such as data packets 300, 700 and/or 900 described above.

Hardware processor 1102 may execute instruction 1108 to determine, by the resonator driver, that the first data packet is assigned to the optical resonator based on information contained in a header field of the first data packet. For example, as described above in connection with FIGS. 1-10, hardware processor 1102 may execute instruction 1108 to obtain a resonator identifier from the header field of the first data packet, and compare the resonator identifier with a local identifier of the optical resonator stored in the resonator driver. In this case, the determination at instruction 1108 may include determining that the resonator identifier matches the local identifier. In examples, the optical resonator may be one of optical resonators 202, optical resonator 506, optical resonator 606, and/or one of the optical resonators included in modulation system(s) 114 or demodulation system(s) 124.

Hardware processor 1102 may execute instruction 1110 to, based on the determination at instruction 1108, tune a resonance wavelength of the optical resonator by controlling a tuning mechanism coupled to the optical resonator according to a payload of the first data packet. In examples, tuning the resonance wavelength of the optical resonator may be responsive to determining that the resonator identifier matches the local identifier. The tuning mechanism may be part of tuning system 116 and/or 126. In examples, the tuning mechanism may be one of tuning mechanism 218, 516, and/or 604a-604n, described above.

Hardware processor 1102 may execute instruction 1112 to, based on the determination at instruction 1108, measure, by a photodetector, an intensity of an optical signal resonating in the optical resonator. In some examples, hardware processor 1102 may execute instruction 1112 to hold the data stream in a buffer stage (e.g., buffer stage 512 or 612) for an amount of time set to allow the tuning mechanism to return to steady state and measure the intensity. The hardware processor 1102 may execute instructions to create the second data packet by populating a payload of the second data packet with the measured intensity and a header field with the local identifier. The second data packet, in some examples, may be a response data packet (e.g., one of response data packets 224a-224n), such as data packets 400, 800 and/or 1000 described above.

Hardware processor 1102 may execute instruction 1114 to insert a second data packet into the data stream, the second data packet comprising the measured intensity of the optical signal. In some examples, hardware processor 1102 may execute instruction 1114 replace the first data packet in the data stream with the second data packet, and after replacing the first data packet, release the data stream.

In some examples, the hardware processor 1102 may execute instructions to pass the first data packet to another optical resonator connected downstream to the optical resonator via a control bus responsive to a determination that the resonator identifier does not match the local identifier.

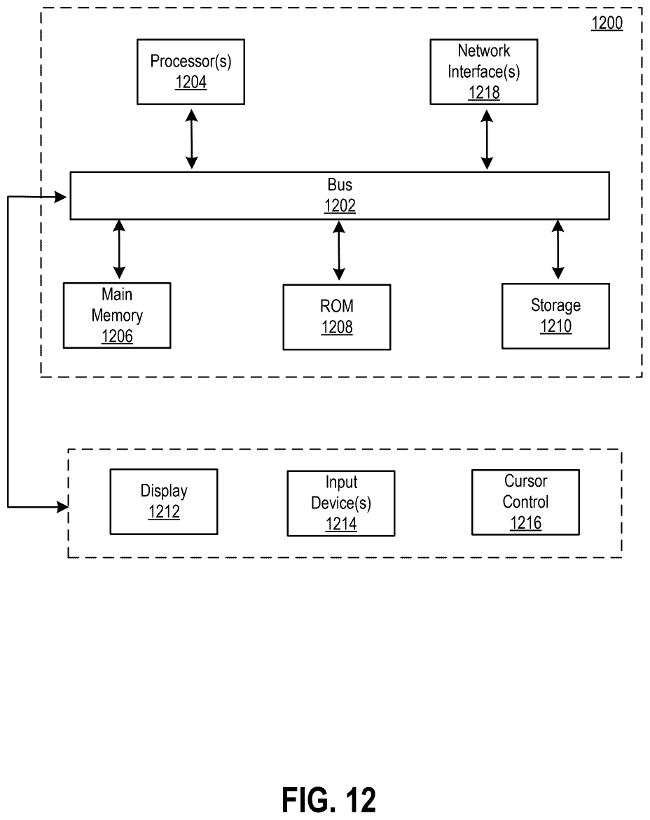

FIG. 12 depicts a block diagram of an example computer system 1200 in which various examples of the disclosed technology described herein may be implemented. The computer system 1200 includes a bus 1202 or other communication mechanism for communicating information, one or more hardware processors 1204 coupled with bus 1202 for processing information. Hardware processor(s) 1204 may be, for example, one or more general purpose microprocessors. The computer system 1200 may be implemented as one or more component of the optical communication system 100. In examples, computer system 1200 may be implemented as one or more of resonator controller 206 and/or resonator driver 220 of FIG. 2, resonator driver 500 of FIG. 5, and/or resonator driver 600 of FIG. 6.

The computer system 1200 also includes a main memory 1206, such as a random access memory (RAM), cache and/or other dynamic storage devices, coupled to bus 1202 for storing information and instructions to be executed by processor 1204. Main memory 1206 also may be used for storing temporary variables or other intermediate information during execution of instructions to be executed by processor 1204. Such instructions, when stored in storage media accessible to processor 1204, render computer system 1200 into a special-purpose machine that is customized to perform the operations specified in the instructions. For example, main memory 1206 may store instructions, that when executed by processor(s) 1204, cause computer system 1200 to perform one or more of the operations described in connection with FIG. 11.

The computer system 1200 further includes a read only memory (ROM) 1208 or other static storage device coupled to bus 1202 for storing static information and instructions for processor 1204. A storage device 1210, such as a magnetic disk, optical disk, or USB thumb drive (Flash drive), etc., is provided and coupled to bus 1202 for storing information and instructions.

The computer system 1200 may be coupled via bus 1202 to a display 1212, such as a liquid crystal display (LCD) (or touch screen), for displaying information to a computer user. An input device 1214, including alphanumeric and other keys, is coupled to bus 1202 for communicating information and command selections to processor 1204. Another type of user input device is cursor control 1216, such as a mouse, a trackball, or cursor direction keys for communicating direction information and command selections to processor 1204 and for controlling cursor movement on display 1212. In some examples, the same direction information and command selections as cursor control may be implemented via receiving touches on a touch screen without a cursor.

The computing system 1200 may include a user interface module to implement a GUI that may be stored in a mass storage device as executable software codes that are executed by the computing device(s). This and other modules may include, by way of example, components, such as software components, object-oriented software components, class components and task components, processes, functions, attributes, procedures, subroutines, segments of program code, drivers, firmware, microcode, circuitry, data, databases, data structures, tables, arrays, and variables.

In general, the word “component,” “engine,” “system,” “database,” data store,” and the like, as used herein, can refer to logic embodied in hardware or firmware, or to a collection of software instructions, possibly having entry and exit points, written in a programming language, such as, for example, Java, C or C++. A software component may be compiled and linked into an executable program, installed in a dynamic link library, or may be written in an interpreted programming language such as, for example, BASIC, Perl, or Python. It will be appreciated that software components may be callable from other components or from themselves, and/or may be invoked in response to detected events or interrupts. Software components configured for execution on computing devices may be provided on a computer readable medium, such as a compact disc, digital video disc, flash drive, magnetic disc, or any other tangible medium, or as a digital download (and may be originally stored in a compressed or installable format that requires installation, decompression or decryption prior to execution). Such software code may be stored, partially or fully, on a memory device of the executing computing device, for execution by the computing device. Software instructions may be embedded in firmware, such as an EPROM. It will be further appreciated that hardware components may be comprised of connected logic units, such as gates and flip-flops, and/or may be comprised of programmable units, such as programmable gate arrays or processors.

The computer system 1200 may implement the techniques described herein using customized hard-wired logic, one or more ASICs or FPGAs, firmware and/or program logic which in combination with the computer system causes or programs computer system 1200 to be a special-purpose machine. According to one example of the disclosed technology, the techniques herein are performed by computer system 1200 in response to processor(s) 1204 executing one or more sequences of one or more instructions contained in main memory 1206. Such instructions may be read into main memory 1206 from another storage medium, such as storage device 1210. Execution of the sequences of instructions contained in main memory 1206 causes processor(s) 1204 to perform the process steps described herein. In alternative examples, hard-wired circuitry may be used in place of or in combination with software instructions.

The term “non-transitory media,” and similar terms, as used herein refers to any media that store data and/or instructions that cause a machine to operate in a specific fashion. Such non-transitory media may comprise non-volatile media and/or volatile media. Non-volatile media includes, for example, optical or magnetic disks, such as storage device 1210. Volatile media includes dynamic memory, such as main memory 1206. Common forms of non-transitory media include, for example, a floppy disk, a flexible disk, hard disk, solid state drive, magnetic tape, or any other magnetic data storage medium, a CD-ROM, any other optical data storage medium, any physical medium with patterns of holes, a RAM, a PROM, and EPROM, a FLASH-EPROM, NVRAM, any other memory chip or cartridge, and networked versions of the same.

Non-transitory media is distinct from but may be used in conjunction with transmission media. Transmission media participates in transferring information between non-transitory media. For example, transmission media includes coaxial cables, copper wire and fiber optics, including the wires that comprise bus 1202. Transmission media can also take the form of acoustic or light waves, such as those generated during radio-wave and infra-red data communications.

The computer system 1200 also includes a network interface 1218 (also referred to as a communication interface) coupled to bus 1202. Network interface 1218 provides a two-way data communication coupling to one or more network links that are connected to one or more local networks. For example, communication interface 1218 may be an integrated services digital network (ISDN) card, cable modem, satellite modem, or a modem to provide a data communication connection to a corresponding type of telephone line. As another example, network interface 1218 may be a local area network (LAN) card to provide a data communication connection to a compatible LAN (or WAN component to communicated with a WAN). Wireless links may also be implemented. In any such implementation, network interface 1218 sends and receives electrical, electromagnetic or optical signals that carry digital data streams representing various types of information.

A network link typically provides data communication through one or more networks to other data devices. For example, a network link may provide a connection through local network to a host computer or to data equipment operated by an Internet Service Provider (ISP). The ISP in turn provides data communication services through the world wide packet data communication network now commonly referred to as the “Internet.” Local network and Internet both use electrical, electromagnetic or optical signals that carry digital data streams. The signals through the various networks and the signals on network link and through network interface 1218, which carry the digital data to and from computer system 1200, are example forms of transmission media.

The computer system 1200 can send messages and receive data, including program code, through the network(s), network link and network interface 1218. In the Internet example, a server might transmit a requested code for an application program through the Internet, the ISP, the local network and the network interface 1218.

The received code may be executed by processor 1204 as it is received, and/or stored in storage device 1210, or other non-volatile storage for later execution.

Each of the processes, methods, and algorithms described in the preceding sections may be embodied in, and fully or partially automated by, code components executed by one or more computer systems or computer processors comprising computer hardware. The one or more computer systems or computer processors may also operate to support performance of the relevant operations in a “cloud computing” environment or as a “software as a service” (SaaS). The processes and algorithms may be implemented partially or wholly in application-specific circuitry. The various features and processes described above may be used independently of one another, or may be combined in various ways. Different combinations and sub-combinations are intended to fall within the scope of this disclosure, and certain method or process blocks may be omitted in some implementations. The methods and processes described herein are also not limited to any particular sequence, and the blocks or states relating thereto can be performed in other sequences that are appropriate, or may be performed in parallel, or in some other manner. Blocks or states may be added to or removed from the disclosed examples. The performance of certain of the operations or processes may be distributed among computer systems or computers processors, not only residing within a single machine, but deployed across a number of machines.

As used herein, a circuit might be implemented utilizing any form of hardware, software, or a combination thereof. For example, one or more processors, controllers, ASICs, PLAs, PALs, CPLDs, FPGAs, logical components, software routines or other mechanisms might be implemented to make up a circuit. In implementation, the various circuits described herein might be implemented as discrete circuits or the functions and features described can be shared in part or in total among one or more circuits. Even though various features or elements of functionality may be individually described or claimed as separate circuits, these features and functionality can be shared among one or more common circuits, and such description shall not require or imply that separate circuits are required to implement such features or functionality. Where a circuit is implemented in whole or in part using software, such software can be implemented to operate with a computing or processing system capable of carrying out the functionality described with respect thereto, such as computer system 1200.

As used herein, the term “or” may be construed in either an inclusive or exclusive sense. Moreover, the description of resources, operations, or structures in the singular shall not be read to exclude the plural. Conditional language, such as, among others, “can,” “could,” “might,” or “may,” unless specifically stated otherwise, or otherwise understood within the context as used, is generally intended to convey that certain examples include, while other examples do not include, certain features, elements and/or steps.

Terms and phrases used in this document, and variations thereof, unless otherwise expressly stated, should be construed as open ended as opposed to limiting. Adjectives such as “conventional,” “traditional,” “normal,” “standard,” “known,” and terms of similar meaning should not be construed as limiting the item described to a given time period or to an item available as of a given time, but instead should be read to encompass conventional, traditional, normal, or standard technologies that may be available or known now or at any time in the future. The presence of broadening words and phrases such as “one or more,” “at least,” “but not limited to” or other like phrases in some instances shall not be read to mean that the narrower case is intended or required in instances where such broadening phrases may be absent.

What is claimed is:

1. A system comprising:
a plurality of resonators coupled to a plurality of tuning mechanisms;
a control bus connected to the plurality of tuning mechanisms; and
a resonator controller configured to input a data stream onto the control bus, wherein the data stream comprises a plurality of request data packets, the request data packets of the plurality of request data packets being assigned to respective ones of the plurality of resonators, and
wherein the plurality of tuning mechanisms are configured to adjust resonance wavelengths of the plurality of resonators based on receiving the data stream.

2. The system of claim 1, wherein the plurality of tuning mechanisms are configured to tune a resonance wavelength of the plurality of resonators.

3. The system of claim 1, wherein the plurality of resonators comprises a microring resonator.

4. The system of claim 1, wherein the plurality of tuning mechanisms comprises one or more of: a resistive heater or a metal-oxide-semiconductor capacitor.

5. The system of claim 1, wherein the plurality of tuning mechanisms are configured to adjust a resonance wavelength of a coupled resonator of the plurality of resonators based on receiving a request data packet of the data stream assigned to the respective resonator.

6. The system of claim 1, wherein the request data packets comprises headers and payloads, wherein the headers comprise a first header field encoded with a packet identifier and a second header field encoded with a resonator identifier, and wherein the payloads comprise tuning mechanism drive parameters.

7. The system of claim 6, wherein the plurality of resonators comprises:
a resonator driver configured to:
receive the plurality of request data packets of the data stream;
compare a resonator identifier encoded into the first header field of a first request data packet of the plurality of request data packets with a locally stored identifier of a respective resonator; and
responsive to the resonator identifier matching the locally stored identifier, forward a tuning parameter contained in the payload of the first request data packet to a tuning mechanism of the plurality of tuning mechanisms coupled to a respective resonator, wherein the tuning mechanism adjusts a resonance wavelength of the respective resonator based on the tuning parameter.

8. The system of claim 7, wherein the resonator driver is further configured to:
responsive to the resonator identifier not matching the locally stored identifier, pass the first request data packet to a downstream resonator of the plurality of resonators.

9. The system of claim 7, wherein the resonator driver is further configured to:
responsive to the resonator identifier matching the locally stored identifier:
hold request data packets that are subsequent to the first request data packet in the data stream;
create a response data packet by reading a photodetector coupled to the respective resonator and populating a payload of the response data packet with a result of the reading;
replace the first request data packet in the data stream with the response data packet; and
after replacing the first request data packet, release the data stream to a downstream resonator of the plurality of resonators.

10. A method, comprising:
receiving, by a resonator driver, a first data packet of a data stream, wherein the resonator driver is associated with an optical resonator;
determining, by the resonator driver, that the first data packet is assigned to the optical resonator based on information contained in a header field of the first data packet;
based on the determination:
tuning a resonance wavelength of the optical resonator by controlling a tuning mechanism coupled to the optical resonator according to a payload of the first data packet; and
measuring, by a photodetector, an intensity of an optical signal resonating in the optical resonator; and
insert a second data packet into the data stream, the second data packet comprising the measured intensity of the optical signal.

11. The method of claim 10, further comprising:
obtaining a resonator identifier from the header field of the first data packet; and
comparing the resonator identifier with a local identifier of the optical resonator stored in the resonator driver;
wherein determining that the first data packet is assigned to the optical resonator comprises determining that the resonator identifier matches the local identifier.

12. The method of claim 11, wherein tuning the resonance wavelength of the optical resonator is responsive to determining that the resonator identifier matches the local identifier.

13. The method of claim 11, further comprising:
responsive determining that the resonator identifier matches the local identifier:
holding the data stream in a buffer stage;
creating the second data packet by populating a payload of the second data packet with the measured intensity and a header field with the local identifier;
replacing the first data packet in the data stream with the second data packet; and
after replacing the first data packet, releasing the data stream.

14. The method of claim 11, further comprising:
responsive to a determination that the resonator identifier does not match the local identifier, pass the first data packet to another optical resonator connected downstream to the optical resonator via a control bus.

15. A system comprising:
a memory comprising instructions;
a hardware processor communicably connected to the memory and configured to execute the instructions to:
receive, by a resonator driver, a first data packet of a data stream, wherein the resonator driver is associated with an optical resonator;
determine, by the resonator driver, that the first data packet is assigned to the optical resonator based on information contained in a header field of the first data packet;
based on the determination,
tune a resonance wavelength of the optical resonator by controlling a tuning mechanism coupled to the optical resonator according to a payload of the first data packet; and
measure, by a photodetector, an intensity of an optical signal resonating in the optical resonator; and
insert a second data packet into the data stream, the second data packet comprising the measured intensity of the optical signal.

16. The system of claim 15, wherein the hardware processor is further configured to execute the instruction to:
obtain a resonator identifier from the header field of the first data packet; and
compare the resonator identifier with a local identifier of the optical resonator stored in the resonator driver;
wherein determining that the first data packet is assigned to the optical resonator comprises determining that the resonator identifier matches the local identifier.

17. The system of claim 16, wherein tuning the resonance wavelength of the optical resonator is responsive to determining that the resonator identifier matches the local identifier.

18. The system of claim 16, wherein the hardware processor is further configured to execute the instruction to:
responsive determining that the resonator identifier matches the local identifier:
hold the data stream in a buffer stage;
create the second data packet by populating a payload of the second data packet with the measured intensity and a header field with the local identifier;
replace the first data packet in the data stream with the second data packet; and
after replacing the first data packet, release the data stream.

19. The system of claim 16, wherein the hardware processor is further configured to execute the instruction to:
responsive to a determination that the resonator identifier does not match the local identifier, pass the first data packet to another optical resonator connected downstream to the optical resonator via a control bus.

20. The system of claim 15, wherein the optical resonator is connected to one or more optical resonators over a control bus, wherein the data stream is received by the resonator driver via the control bus.
